(19) United States
(12) Patent Application Publication
(10) Pub. No.: US 2007/0003309 A1
(43) Pub. Date: Jan. 4, 2007

(54) Developer cartridge and image forming apparatus having the same

(75) Inventors: Jun-hee Lee, Suwon-si (KR); Byung-sun Ahn, Suwon-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/439,206

(22) Filed: May 24, 2006

(30) Foreign Application Priority Data
Jun. 29, 2005 (KR) 2005-57231

(51) Int. Cl. G03G 15/00

(52) U.S. Cl. 399/90

(57) ABSTRACT

A developer cartridge, including: a removable cartridge main body installed in an image forming apparatus main body; a rotating photosensitive drum installed inside the cartridge main body; an information storage unit provided in the photosensitive drum; and a connecting unit connecting the information storage unit and a controller installed at the image forming apparatus main body for signal communication therebetween; and an image forming apparatus having the developer cartridge.

### CROSS-REFERENCE TO RELATED APPLICATIONS

This application claims the benefit of Korean Application No. 2005-57231, filed Jun. 29, 2005, in the Korean Intellectual Property Office, the disclosure of which is incorporated herein by reference.

### BACKGROUND OF THE INVENTION

1. Field of the Invention

An aspect of the present invention relates to a developer cartridge and an image forming apparatus having the same.

2. Description of the Related Art

In general, image forming apparatuses include MFPs (multi-function printer), copiers, fax machines, laser printers, etc.

As an example, a laser printer main body is equipped with a developing unit, a fixing unit, and a laser scanning unit. Also, a paper feeding tray for feeding a recording medium, like paper, to the developing unit is installed at the lower portion of the main body.

In the case of a dry printer, the developing unit includes a developer cartridge and a transfer roller. The developer cartridge is detachably installed in the main body. Developer cartridges are generally replaceable after use of the developer inside. The developer cartridge comprises a cartridge main body for keeping a powder developer (e.g., toner), a photosensitive drum housed in the cartridge main body, a developing roller for supplying the developer to the photosensitive drum, and a supply roller for supplying the developer to the developing roller.

An image formed on the photosensitive drum is transferred onto a sheet of paper passing between the drum and the transfer roller. Then the image is fixed by a fixing unit at high temperature and high pressure. Finally, the paper bearing the image is discharged to the outside.

The developer cartridge also has an information storage unit for storing predetermined information. Examples of such information include a list for repair/replacement of the developer cartridge, manufacturing date, and standard and reference information.

The information storage unit is built to be able to communicate information with a controller of the printer main body. Therefore, useful information required for image formation is exchanged, which in turn contributes to the improvement in image quality. To this end, a connector electrically connectable to the controller is installed on the outside of the developer cartridge.

However, this causes both the developer cartridge and the printer to become large, as the separate connector is placed on the outside of the developer cartridge.

In addition, since the developer cartridge requires a separate space for installation of the information storage unit, its size is increased even more.

Moreover, when the information storage unit is exposed to the outside of the developer cartridge, it can easily be contaminated by dust or other impurities. And, when the information storage unit is easily detachable from the developer cartridge, it becomes vulnerable to theft or hacking by a reproducer. Although the information storage unit is reusable by hacking, this is unjust and may damage many customers who use qualifying products.

### SUMMARY OF THE INVENTION

According to an aspect of the present invention, there is provided an improved developer cartridge capable of accommodating a connector and an information storage unit inside of it, and an image forming apparatus having the same.

To achieve the above and/or other aspects and advantages, there is provided a developer cartridge, including: a cartridge main body detachably installed in an image forming apparatus main body; a rotating photosensitive drum installed inside the cartridge main body; an information storage unit provided in the photosensitive drum; and a connecting unit for connecting the information storage unit with a controller installed at the image forming apparatus main body for signal communication therebetween.

The connecting unit may, although not necessarily, comprise: a drum cap pressed in the end portion of the photosensitive drum and having a shaft hole formed therein; a hollow shaft, which is inserted into the shaft hole and provided to the cartridge main body for supporting the rotation of the drum cap; and a connecting pipe, which is inserted into the hollow shaft, and has one end connected to the information storage unit and the other exposed to the outside of the cartridge main body so as to be connected to the controller.

The connecting pipe may, although not necessarily, be made of a conductive material.

The information storage unit may, although not necessarily, comprise: a connecting unit connected to the connecting pipe for support; a memory unit for storing information; and a wired/wireless communication unit for enabling wired and wireless information exchange with the controller.

The connecting unit of the information storage unit may, although not necessarily, comprise a plurality of connecting pins for enabling wired communication with the memory unit.

The drum cap may, although not necessarily, comprise: a gear having a proper number of teeth formed on the outer circumference; and a coupling part connected to the gear and pressed in the end portion of the photosensitive drum.

The connecting unit of the developer cartridge may, although not necessarily, comprise: a connecting cable, which is inserted into the connecting pipe and has one end connected to the information storage unit; and a terminal case, which is connected to the connecting pipe for enabling signal communication from the controller, when in contact with the controller, and through the connecting cable.

The terminal case may, although not necessarily, comprise: a coupling part for receiving one end portion of the connecting pipe recessively therewithin; a plurality of connecting pins formed on the bottom surface of the coupling part, and connected to the connecting cable; and a plurality of terminals formed on the other surface and electrically connected to the controller.

The connecting cable may, although not necessarily, be a harness consisting of three signal lines and a connector formed on both ends, respectively.

The connecting pipe may, although not necessarily, comprise: a pipe-shaped inserting part, which is inserted into the hollow shaft and connected to the information storage unit; and a head part, which is extended from one end of the inserting part and exposed to the outside of the cartridge main body so as to connect to the controller.

Another aspect of the present invention provides an image forming apparatus, comprising: a main body having a cartridge mount in an openable/closable manner through a door; a developer cartridge installed detachably on the cartridge mount; a controller installed in the main body and connected to the developer cartridge which is mounted on the cartridge mount, wherein, the developer cartridge includes: a cartridge main body; a rotating photosensitive drum installed inside the cartridge main body; an information storage unit provided in the photosensitive drum; and a connecting unit for connecting the information storage unit with a controller installed at the image forming apparatus main body for signal communication therebetween.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a schematic view of an image forming apparatus according to an embodiment of the present invention;

FIG. 2 is a schematic view for explaining a developer cartridge according to an embodiment of the present invention;

FIG. 3 is a schematic front view of an assembled developer cartridge of FIG. 2;

FIG. 4 is a cross-sectional view of FIG. 3

FIG. 5 is a perspective view of an information storage unit excerpted from FIG. 2;

FIG. 6 is a schematic view for explaining a developer cartridge according to another embodiment of the present invention;

FIG. 7 is a cross-sectional view of FIG. 6;

FIG. 8 is a plan view of a connecting cable excerpted from FIG. 6; and

FIG. 9A and FIG. 9B are schematic views of a terminal case shown in FIG. 6.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

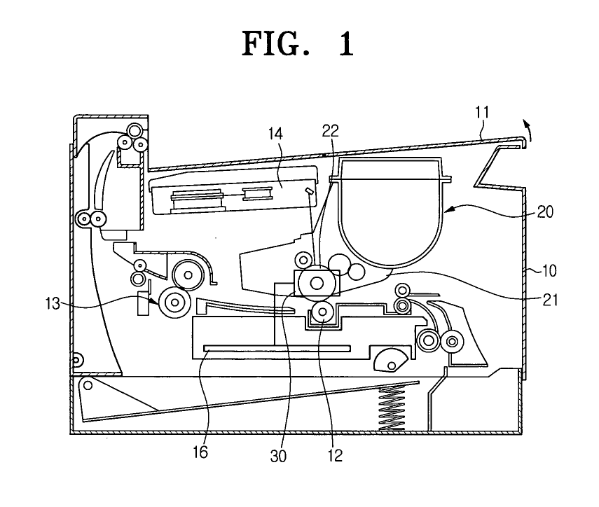

Referring to FIG. 1, an image forming apparatus according to an embodiment of the present invention comprises an image forming apparatus main body 10 (hereinafter it will be referred simply as a main body), a developer cartridge 20 detachably installed in the main body 10, and a controller 30 disposed correspondingly to a developer cartridge mount portion in the main body 10 to be electrically connected to the developer cartridge 20.

The main body 10 comprises a door 11 installed in an openable/closable manner for installation and separation of the developer cartridge 20. The main body 10 also comprises a transfer roller 12 rotating in contact with a photosensitive drum 22 of the developer cartridge 20, and a fixing unit for fixing an image onto a paper sheet, on which the image is transferred as the paper sheet passes through the transfer roller 12 and the photosensitive drum 22, at high temperature and high pressure. Moreover, the main body 10 comprises a laser scanning unit 14 for scanning laser beams onto the photosensitive drum 22 to form an electrostatic latent image. These components are commonly used in general electrophotographic laser printers, and therefore a detailed explanation of those components will be omitted hereafter. Reference numeral 16 in FIG. 1 denotes a printed circuit board (PCB) that is electrically connected to the controller 30.

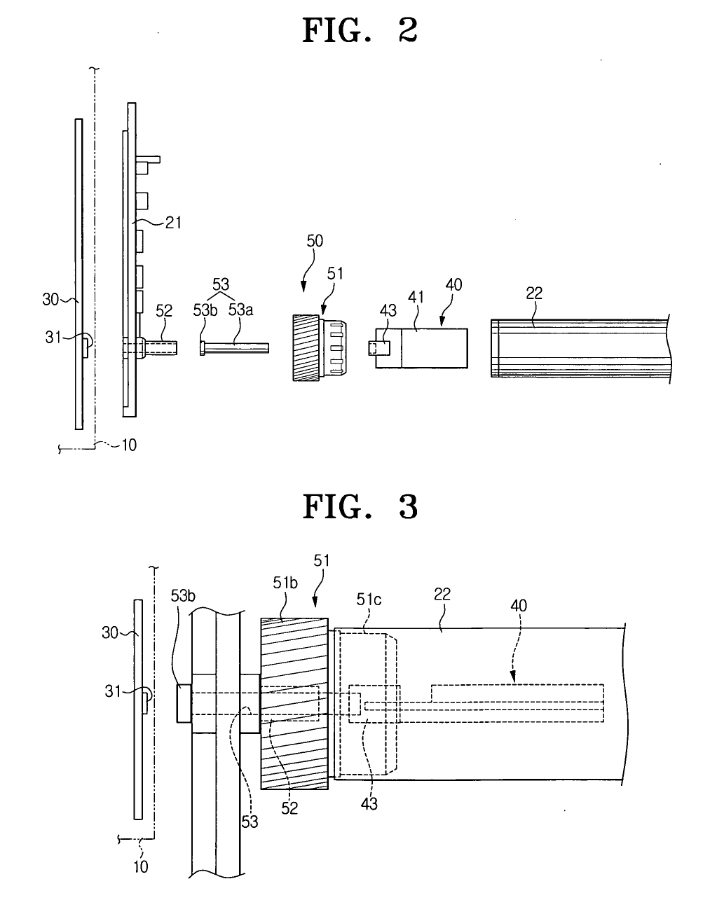

The developer cartridge 20 comprises a cartridge main body 21, and the rotating photosensitive drum 22 (please see FIG. 2) installed in the main body 21.

Referring now to FIGS. 2, 3, 4, and 5, an information storage unit 40 is provided in the photosensitive drum 22. As depicted in FIG. 5, the information storage unit 40 comprises a body 41, and a connecting unit 43 attached to the body 41. The body 41, as illustrated in FIG. 5, is divided into two parts with respect to a support unit 41a at the center: a memory unit 41b and a wired/wireless communication unit 41c. The memory unit 41b is a memory for storing predetermined information, and may be formed of a PCB. Likewise, the wired/wireless communication unit 41c may be formed of a PCB having a built-in antenna for enabling wired and/or wireless communication externally, i.e., with the controller 30.

The connecting unit 43 of the information storage unit 40 comprises a coupling hole 43a formed at the end at a predetermined depth, and a plurality of (i.e., three) connecting pins 43b provided to the bottom surface of the coupling hole 43a. Each connecting pin 43b is used for the wired communication: one for voltage, another for data transfer, and the other for clock signal.

Furthermore, the developer cartridge 20 comprises a connecting unit 50 for electrically connecting the information storage unit 40 to the controller 30.

Referring to FIGS. 2 and 3, the connecting unit 50 of the developer cartridge comprises a drum cap 51 pressed in the end portion of the photosensitive drum 22, a hollow shaft 52 provided to the cartridge main body 21 for supporting the rotation of the drum cap 51, a connecting pipe 53 passing through the hollow shaft 52 for supporting the information storage unit 40 inside the photosensitive drum 22.

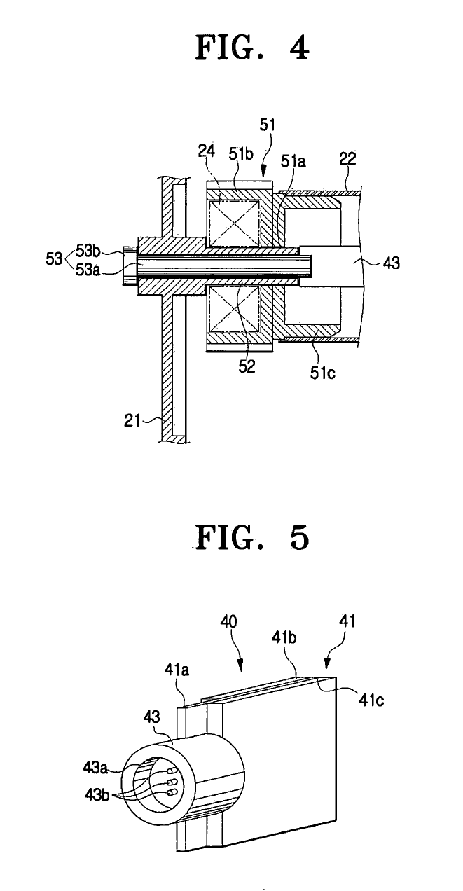

As shown in FIG. 4, the drum cap 51 has a shaft hole 51a that the hollow shaft 52 passes through. The drum cap 51 comprises a gear 51c having a proper number of teeth formed on the outer circumference, and a coupling part 51b connected to the gear 51a and pressed in the end portion of the photosensitive drum 22. Therefore, provided that the coupling part 51b is pressed in the photosensitive drum 22, when power is transferred to the gear 51 from the outside, the cap 51 and the photosensitive drum 22 rotate together.

The hollow shaft 52 is installed at the cartridge main body 21. Both ends of the hollow shaft 52 are open. The hollow shaft 52 is inserted into the shaft hole 51a of the cap 51. And a bearing 24 (refer to FIG. 4) is installed between the cap 51 and the hollow shaft 52 to support the rotation of the cap 51 with respect to the hollow shaft 52.

The connecting pipe 53 is inserted into the hollow shaft 52 from the outside of the cartridge main body 21. The connecting pipe 53 has an inserting part 53a which is inserted into the hollow shaft 52, and a head part 53b extended from one end of the inserting part 53a. Therefore, when the connecting pipe 53 is inserted into the hollow shaft 52, only the inserting part 53a is inserted into the hollow 52a, whereas the head part 53b is exposed to the outside of the main body 21. The end of the inserting part 53a, is inserted into the coupling hole 43a of the connecting unit 43 of the information storage unit 40. Now that the information storage unit 40 is connected to and supported by the connecting pipe 53, its installation inside the photosensitive drum 22 can be done more stably, irrespective of the rotation of the photosensitive drum 22.

As aforementioned, the head part 53b of the connecting pipe 53 is exposed to the outside of the main body 21. Since the connecting pipe 53 is made of conductive materials, e.g., metal, when the head part 53b comes in electrical contact with the terminal 31, the controller 30 and the information storage unit 40 are also connected electrically to each other. Hence, an electric signal (electric wave) can be transferred to the information storage unit 40 through the connecting pipe 53. The information storage unit 40, which receives an electric signal (electric wave), can now receive and transmit information wirelessly with the controller 30 through the wired/wireless communication unit 41c.

That is, the connecting pipe 53 functions as a conductor and supports the connection of the information storage unit 40 at the same time. Therefore, when the developer cartridge 20 is installed inside the main body 10, the head part 53b of the connecting pipe 53 is connected to the terminal 31 of the controller 30, and this makes it possible for the controller 30 to wirelessly communicate information with the information storage unit 40. Unlike the related art, the information storage unit 40 is not installed on the outside of the developer cartridge 20, but in the photosensitive drum 22 on the inside of the developer cartridge 20 and therefore, no separate installation space is required. This opens the possibility for the manufacture of a small-sized developer cartridge 20. Moreover, since the information storage unit 40 is hidden inside the photosensitive drum 22, it can be protected from contamination like dust.

The fact that the information storage unit 40 is built inside the photosensitive drum 22 makes it difficult to separate the information storage unit 40 during the regeneration of the developer cartridge 20, and therefore the information storage unit 40 can be protected from hacking.

Meanwhile, as the controller 30 is installed in the main body 10, it can include a printed circuit board (PCB).

So far, the wireless communication between the information storage unit 40 and the controller 30 has been explained with reference to FIGS. 1-5. The following will now describe an embodiment where both wired and wireless communications are possible.

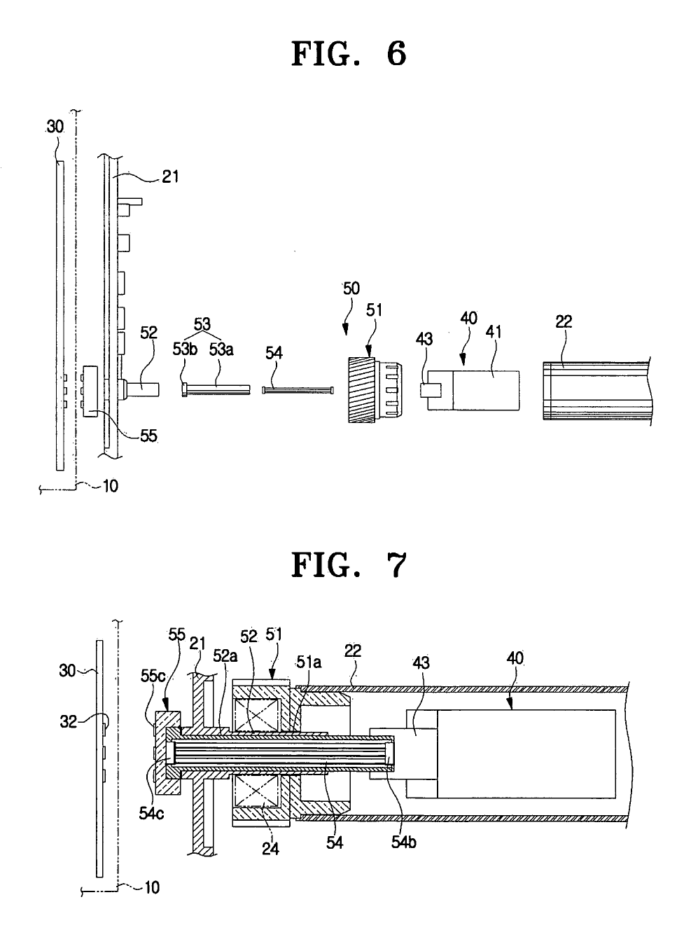

The developer cartridge shown in FIGS. 6 and 7 is characterized by further comprising a terminal case 55 and a connecting cable 54 for use in wired communication between the information storage unit 40 installed in the photosensitive drum 22 and the controller 30. In this embodiment, the connecting pipe 53 is hollow and open on both ends.

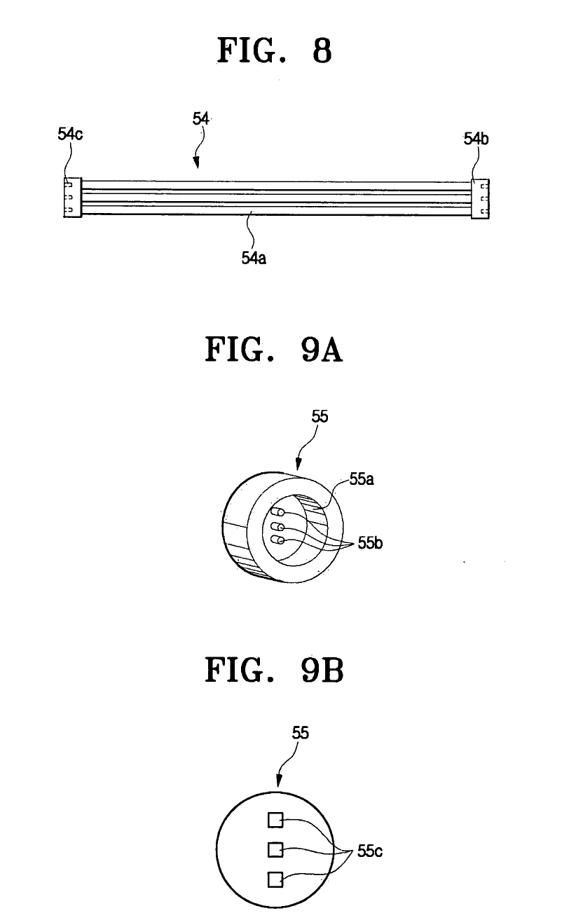

As shown in FIG. 8, the connecting cable 54 is preferably a harness having three signal lines 54a, and a first and a second connector 54b, 54c formed on both ends of the signal lines 54a, respectively. The three signal lines 54a are provided correspondingly to the connecting pins 43b of the connecting unit 43 of the information storage unit 40.

In detail, the connecting cable 54 is inserted into the connecting pipe 53, and the first connector 54b is connected to the connecting pin 43b of the connecting unit 43 for the information storage unit 40. Meanwhile, the second connector 54c is exposed to the outside of the main body 21 through the connecting pipe 53, and is connected to the terminal case 55.

Referring now to FIGS. 9A and 9B, the terminal case 55 comprises a coupling part 55a for receiving the head part 53b of the connecting pipe 53 recessively therewithin, and three connecting pins 55b formed on the bottom surface of the coupling part 55a. The outer surface of the terminal case 55 comprises terminals 55c electrically connected to their respective connecting pins 55b. These terminals 55c are also electrically connected to the terminals 32 of the controller 30.

According to this configuration, when the connecting cable 54 is inserted into the connecting pipe 53, the information storage unit 40 and the controller 30 are ready for wired information exchange and power connection therebetween, and through the connecting pipe 53 both are connected electrically and can be grounded. In this case, a part of the information storage unit 40 can be grounded in contact with the inner circumference of the photosensitive drum 22. Since this configuration is commonly understood by one of ordinary skill in the art, details thereof will not be provided here.

As explained so far, the present invention opens up the possibility for the manufacture of a small-sized developer cartridge by installing the information storage unit inside the photosensitive drum of the developer cartridge. Thus, according to the present invention, a separate installation space for the information storage unit is no longer required.

Moreover, since the information storage unit is installed inside the photosensitive drum, it is not exposed to the outside and is thus protected from contamination.

As the information storage unit is installed inside the photosensitive drum in a specific manner, it is not easy to separate the two. Practically, separation of the information storage unit for the regeneration of the developer cartridge is not easy without breaking the photosensitive drum. Although someone may succeed in separating the information storage unit, there is a high possibility that the information storage unit may be damaged in doing so. In this way, damage caused by hacking or reuse is avoided, or at least reduced.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A developer cartridge for use in an image forming apparatus having a main body and a controller, the developer cartridge comprising:
a removable cartridge main body installed in the image forming apparatus main body;
a rotating photosensitive drum installed inside the cartridge main body;
an information storage unit provided inside the photosensitive drum; and
a connecting unit connecting the information storage unit with the controller for signal communication therebetween.

2. The developer cartridge as claimed in claim 1, wherein the connecting unit comprises a connecting pipe, which has one end connected to the information storage unit and the other end exposed to the outside of the cartridge main body so as to be connected to the controller.

3. The developer cartridge as claimed in claim 2, wherein the connecting unit further comprises:
a drum cap pressed in an end portion of the photosensitive drum, and having a shaft hole formed therein; and
a hollow shaft, which is inserted into the shaft hole and provided to the cartridge main body for supporting a rotation of the drum cap, and is open on each side to allow the connecting pipe to fit therein.

4. The developer cartridge as claimed in claim 2, wherein the connecting pipe is made of a conductive material.

5. The developer cartridge as claimed in claim 2, wherein the information storage unit comprises:
a connecting unit connected to the connecting pipe for support;
a memory unit storing information useful for image formation; and
a wired and/or wireless communication unit enabling wired and/or wireless information exchange with the controller.

6. The developer cartridge as claimed in claim 5, wherein the connecting unit comprises a plurality of connecting pins enabling wired communication with the memory unit.

7. The developer cartridge as claimed in claim 3, wherein the drum cap comprises:
a rotating gear that connects to the rotating photosensitive drum; and
a coupling part connected to the gear and pressed in an end portion of the photosensitive drum.

8. The developer cartridge as claimed in claim 7, wherein the gear has a proper number of teeth to connect to the rotating photosensitive drum formed on the outer circumference.

9. The developer cartridge as claimed in claim 2, wherein the connecting unit further comprises:
a connecting cable, which is inserted into the connecting pipe and has one end connected to the information storage unit; and
a terminal case, which is connected to the connecting pipe enabling signal communication with the controller, when in contact with the controller, and through the connecting cable.

10. The developer cartridge as claimed in claim 9, wherein the terminal case comprises:
a coupling part receiving one end portion of the connecting pipe recessively therewithin;
a plurality of connecting pins formed on a bottom surface of the coupling part, and connected to the connecting cable; and
a plurality of terminals formed on an other side of the bottom surface, and electrically connected to the controller.

11. The developer cartridge as claimed in claim 9, wherein the connecting cable is a harness comprising three signal lines and a connector formed on both ends, respectively.

12. The developer cartridge as claimed in claim 3, wherein the connecting pipe comprises:
a pipe-shaped inserting part, which is inserted into the hollow shaft and connected to the information storage unit; and
a head part, which is extended from one end of the inserting part and exposed to an outside of the cartridge main body so as to connect to the controller.

13. An image forming apparatus, comprising:
a main body having a cartridge mount in an openable/closable manner through a door;
a removable developer cartridge installed on the cartridge mount;
a controller installed in the main body and connected to the developer cartridge which is mounted on the cartridge mount, wherein, the developer cartridge comprises:
a cartridge main body;
a rotating photosensitive drum installed inside the cartridge main body;
an information storage unit provided inside the photosensitive drum; and
a connecting unit connecting the information storage unit with the controller for signal communication therebetween.

14. The apparatus as claimed in claim 13, wherein the connecting unit comprises a connecting pipe, which has one end connected to the information storage unit and the other end exposed to the outside of the cartridge main body so as to be connected to the controller.

15. The apparatus as claimed in claim 14, wherein the connecting unit further comprises:
a drum cap pressed in the end portion of the photosensitive drum, and having a shaft hole formed therein;
a hollow shaft, which is inserted into the shaft hole and provided to the cartridge main body for supporting the rotation of the drum cap, and is open on each side to allow the connecting pipe to fit therein.

16. The apparatus as claimed in claim 14, wherein the connecting pipe is made of a conductive material.

17. The apparatus as claimed in claim 14, wherein the information storage unit comprises:
a connecting unit connected to the connecting pipe for support;
a memory unit storing information useful for image formation; and
a wired and/or wireless communication unit for enabling wired and/or wireless information exchange with the controller.

18. The apparatus as claimed in claim 16, wherein the connecting unit further comprises a plurality of connecting pins for enabling wired communication with the memory unit.

19. The apparatus as claimed in claim 15, wherein the drum cap comprises:
a rotating gear that connects to the rotating photosensitive drum; and
a coupling part connected to the gear and pressed in the end portion of the photosensitive drum.

20. The apparatus as claimed in claim 19, wherein the gear has the proper number of teeth to connect to the rotating photosensitive drum formed on the outer circumference.

21. The apparatus as claimed in claim 13, wherein the connecting unit comprises:
a connecting cable, which is inserted into the connecting pipe and has one end connected to the information storage unit; and
a terminal case, which is connected to the connecting pipe enabling signal communication with the controller, when in contact with the controller, and through the connecting cable.

22. The apparatus as claimed in claim 21, wherein the terminal case comprises:
a coupling part for receiving one end portion of the connecting pipe recessively therewithin;
a plurality of connecting pins formed on a bottom surface of the coupling part, and connected to the connecting cable; and
a plurality of terminals formed on an other side of the bottom surface, and electrically connected to the controller.

23. A developer cartridge for use in an image forming apparatus having a controller, comprising:
a rotating photosensitive drum installed inside the cartridge main body;
an information storage unit; and
a connecting unit disposed in an inside region of the developer cartridge for connecting the information storage unit with the controller for signal communication therebetween.

24. The developer cartridge as claimed in claim 23, wherein the information storage unit comprises:
a connecting unit for connecting to the controller;
a memory unit for storing information useful for image formation; and
a wired and/or wireless communication unit for enabling wired and/or wireless information exchange with the controller.

25. The developer cartridge as claimed in claim 24, wherein the connecting unit comprises a plurality of connecting pins enabling wired communication with the memory unit.

26. The developer cartridge as claimed in claim 23, wherein the connecting unit comprises a connecting pipe, which has one end connected to the information storage unit and the other end exposed to the outside of the cartridge main body so as to be connected to the controller.

27. The developer cartridge as claimed in claim 26, wherein the connecting pipe is made of a conductive material.

28. The developer cartridge as claimed in claim 26, wherein the connecting unit further comprises:
a connecting cable, which is inserted into the connecting pipe and has one end connected to the information storage unit; and
a terminal case, which is connected to the connecting pipe enabling signal communication with the controller, when in contact with the controller, and through the connecting cable.

29. The developer cartridge as claimed in claim 28, wherein the terminal case comprises:
a coupling part receiving one end portion of the connecting pipe recessively therewithin;
a plurality of connecting pins formed on a bottom surface of the coupling part, and connected to the connecting cable; and
a plurality of terminals formed on an other side of the bottom surface, and electrically connected to the controller.

30. The developer cartridge as claimed in claim 28, wherein the connecting cable is a harness comprising three signal lines and a connector formed on both ends, respectively.

31. The developer cartridge as claimed in claim 26, wherein the connecting pipe comprises:
a pipe-shaped inserting part, which is inserted into the hollow shaft and connected to the information storage unit; and
a head part, which is extended from one end of the inserting part and exposed to an outside of the cartridge main body so as to connect to the controller.

32. A rotating photosensitive drum for use in a developer cartridge of an image forming apparatus having a controller, the rotating photosensitive drum comprising an information storage unit therein.

33. The developer cartridge as claimed in claim 32, wherein the information storage unit comprises:
a connecting unit connecting to the controller;
a memory unit storing information useful for image formation; and
a wired and/or wireless communication unit enabling wired and/or wireless information exchange with the controller.

34. The developer cartridge as claimed in claim 33, wherein the connecting unit comprises a plurality of connecting pins enabling wired communication with the memory unit.
